(19) United States
(12) Patent Application Publication
(10) Pub. No.: US 2002/0095269 A1
(43) Pub. Date: Jul. 18, 2002

(54) System for monitoring and servicing appliances

(76) Inventors: Francesco Natalini, Fabriano (IT); Giorgio Mosca, Milano (IT)

Correspondence Address: CESARI AND MCKENNA, LLP, 88 BLACK FALCON AVENUE, BOSTON, MA, 02210, US

(21) Appl. No.: 09/761,950

(22) Filed: Jan. 17, 2001

(51) Int. Cl. G06F 11/00; G06F 15/00

(52) U.S. Cl. 702/188

(57) ABSTRACT

An appliance monitoring system for use with household appliances includes subsystems for continuously monitoring the operations of one or more appliances and a gateway through which the subsystems communicate with a remote center that oversees the servicing of the appliances. The subsystem associated with a particular appliance tracks various operating parameters and conditions, such as the total number, type, times, and duration of operating cycles; energy consumption during the cycles; and/or the states of various components such as intake valves, doors, sensors, and so forth, during the operating cycles. The subsystem then analyses the monitored information to determine if the appliance is malfunctioning and/or requires immediate or other attention. If so, the subsystem sends the monitored data and the results of the analysis in the form of an alarm or a warning message to the remote service center, to inform the center that the appliance is in need of attention. The subsystem also periodically sends to the remote center at least the retained statistical data. The remote center includes the data in a more detailed analysis of the operations of the associated appliance, the other appliances in the same household, to determine if other alarm or warning conditions exist. The data may also be analyzed in conjunction with the data from like types of appliances in other households, to determine if operations associated with modes of failure are occurring in a given appliance. Further, the data may also be analyzed to determine the patterns of use of various appliances, to recommend more efficient uses and/or to recommend replacement appliances. The remote center responds to received alarm or warning conditions based on the particular fault or condition and also on a level-of-service contract with the user. If the condition is user-correctable, the remote center contacts the user to correct the condition. If the condition requires emergency or non-emergency service, the remote center arranges the service in accordance with the provisions of the level-of-service contract.

### BACKGROUND OF THE INVENTION

1. Field of the Invention

The invention relates generally to systems for monitoring appliances and, more particularly, to systems for providing maintenance services for the appliances.

2. Background Information

A household typically includes a variety of appliances, such as refrigerators, water heaters, dishwashers, clothes washers and dryers and so forth, that are often made by various manufacturers and purchased at different times. The manufacturers recommends different preventive maintenance schedules for their various appliances. Accordingly, the user is left to determine when to call for maintenance for a given appliance, what type of service to request, and often whom to call to provide the service.

The preventive maintenance schedules set by the manufacturers are generally based on average usage, and thus, may not be applicable a given user. The user may, for example, use an appliance more frequently or at a greater capacity than average, and thus, require service at an earlier date or even a different type of service than what is recommended for average use. In addition, environmental conditions such as water hardness, humidity, air flow and so forth may adversely affect the operations of a given appliance. The appliances or components thereof may therefore require replacing or cleaning at an earlier date than recommended by the manufacturer. Accordingly, the user when requests the recommended service may not be arranging for service at the appropriate time. Conversely, if the appliance use is well below average or the environment is particularly well suited to the appliance, the user who requests the recommended service may be arranging, and thus paying for unneeded service.

An appliance or various components therein may fail, regardless of whether or not the appliance is serviced in accordance with the manufacturer's recommended maintenance schedule. Certain failures, such as those caused by clogged passageways or unevenly wearing components, may be avoided if the user arranges for timely repair. The user must first determine that a failure is imminent, however, and then determine whom to contact to make whatever type of repair is necessary.

The sudden failure or malfunction of critical components, such as a refrigerator compressor, is typically catastrophic to the appliance. The user is then faced with a situation that requires emergency service at what may be a particularly inconvenient time. The user must know whom to call in the emergency and what type of service to request, particularly if the failed component is one that is not typically stocked. The failure or malfunctioning of certain other components may result in an appliance running inefficiently, and thus, using more energy or water. Accordingly, the user may be faced with higher utility bills, without necessarily knowing which of the appliances is responsible.

Many appliances today have built-in “intelligence” that monitors operations and maintains certain information that is useful in managing current operations, assembling operating statistics, and/or diagnosing the cause of appliance malfunction or failure. The intelligent appliance monitors the states of various components, the ambient environment, appliance settings, and so forth, and maintains the information for the most recent operating cycle. The appliance may also aggregate certain of the information over a number of cycles and maintain historical operating information, and/or aggregate the historical information into statistical information relating, for example, to the total number and types of operations the appliance has performed, and so forth. Certain of the information may be then made available to a repairman for assessing overall performance of the appliance. If the appliance is connected to a network that is accessible from outside the home, the repairman may have access to the information before responding to a service call, and in this way diagnose the problem and determine, for example, that a particular part must be replaced.

Even with the intelligent appliances, however, the user has the responsibility of determining when to schedule maintenance or repair service for the various appliances, which appliance problems require immediate service and which can wait, who to call for service of a given appliance, and so forth.

### SUMMARY OF THE INVENTION

An appliance monitoring system operating in accordance with the invention includes subsystems for continuously monitoring the operations of one or more appliances and a gateway through which the subsystems can communicate with a remote center that oversees the servicing of the appliances. The subsystem associated with a particular appliance tracks various operating parameters and conditions, such as the total number, type, times, and duration of operating cycles; energy consumption during the cycles; and/or the states of various components such as intake valves, doors, sensors, and so forth, during the operating cycles. The subsystem then analyses the monitored information to determine if the appliance is malfunctioning and/or requires immediate or other attention. If so, the subsystem sends the monitored data and the results of the analysis in the form of an alarm or a warning message to the remote service center, to inform the center that the appliance is in need of attention. The subsystem also periodically sends to the remote center at least the retained statistical data, which is then included in a more detailed analysis of the operations of the associated appliance and the other appliances in the same household, to determine if other alarm or warning conditions exist. The data may also be analyzed to determine the patterns of use of various appliances, to recommend more efficient uses and/or to recommend replacement appliances.

The remote center responds to a received alarm or warning message or a detected alarm or warning condition based on the fault or condition and also on a level-of-service contract with the user. The center handles an alarm message or condition associated with is an existing or impending catastrophic failure by immediately informing the user of the problem through a pre-arranged communication channel. If covered by the contract, the center also schedules an emergency service call.

The center handles an alarm message or condition which indicates a user-correctable situation that is not catastrophic to the appliance, such as a refrigerator door that has been left open or a water intake valve that has been turned off, by telephoning the home and, as necessary, leaving a message.

When a warning message is received or a warning condition detected, the remote center informs the user about needed non-emergency repairs or preventive maintenance through less urgent channels, such as e-mail. As appropriate, the remote center also schedules the service at a time that is convenient to both the user and the repairman.

As discussed above, the remote center analyzes statistical and other information provided by the appliance monitoring subsystems to determine patterns of usage of the various appliances. Depending on the outcome of the analysis and the indicated condition of a given appliance, the remote center may contact the user to recommend ways to more efficiently use the appliance. When replacement of the appliance is indicated, the remote center may recommend appliance models that best fit the user's patterns of use and, as appropriate, arrange for the delivery and installation of the replacement appliance.

The appliance monitoring system thus continuously monitors and analyzes the operations of the appliances and, as appropriate, directs attention to a particular appliance, recommends or schedules appliance maintenance and repair, and/or recommends or schedules appliance replacement based on the actual operation and use of is the appliance. Accordingly, the system and method of operation of the system use the data produced by the various appliances to provide a user with personalized oversight and care of each of the appliances in the household.

### BRIEF DESCRIPTION OF THE DRAWINGS

The invention description below refers to the accompanying drawings, of which:

FIG. 1 is a functional block diagram of a system constructed in accordance with the invention;

FIG. 2 is a functional block diagram showing an appliance of FIG. 1 in more detail;

FIGS. 3-5 are flow charts of the operations of monitoring subsystems of FIG. 1;

FIG. 6 is a flow chart of the operations of a gateway of FIG. 1;

FIG. 7-9 are flow charts of the operations of a remote center of FIG. 1.

### DETAILED DESCRIPTION OF AN ILLUSTRATIVE EMBODIMENT

A. An Overview of the System

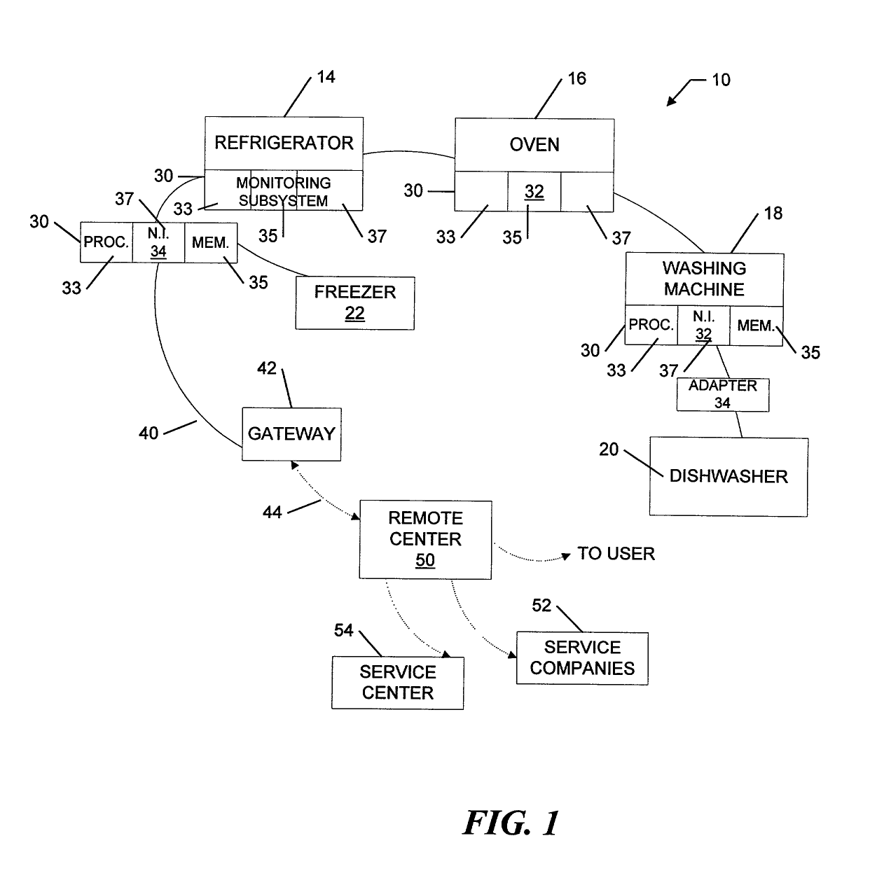

Referring now to FIG. 1, an appliance monitoring system includes a network 10 of one or more household appliances, for example, a refrigerator 14, an oven 16, a washing machine 18, a dishwasher 20, and a freezer 22 that communicate over a communications path 40. Each appliance is associated with a monitoring subsystem 30 that monitors and analyses the operations of the appliance. The monitoring subsystem 30 forwards monitored information, and the results of its analysis in the form of alarm or warning messages over the communications path 40 and through a network gateway 42 to a remote center 50 that is also part of the system.

The messages sent by the various appliances include in a header a message field that identifies the message type. In the exemplary system, there are two types of messages, namely, a warning and an alarm. The message field thus includes a single bit that is set to one value for an alarm message and to another value for a warning message. The message further includes one or more fault codes that identify the detected faults or conditions. If the cause of the malfunction can also be determined, a second fault code that conveys that information may also be included. The subsystem may also combine several different fault codes into a single alarm or warning message.

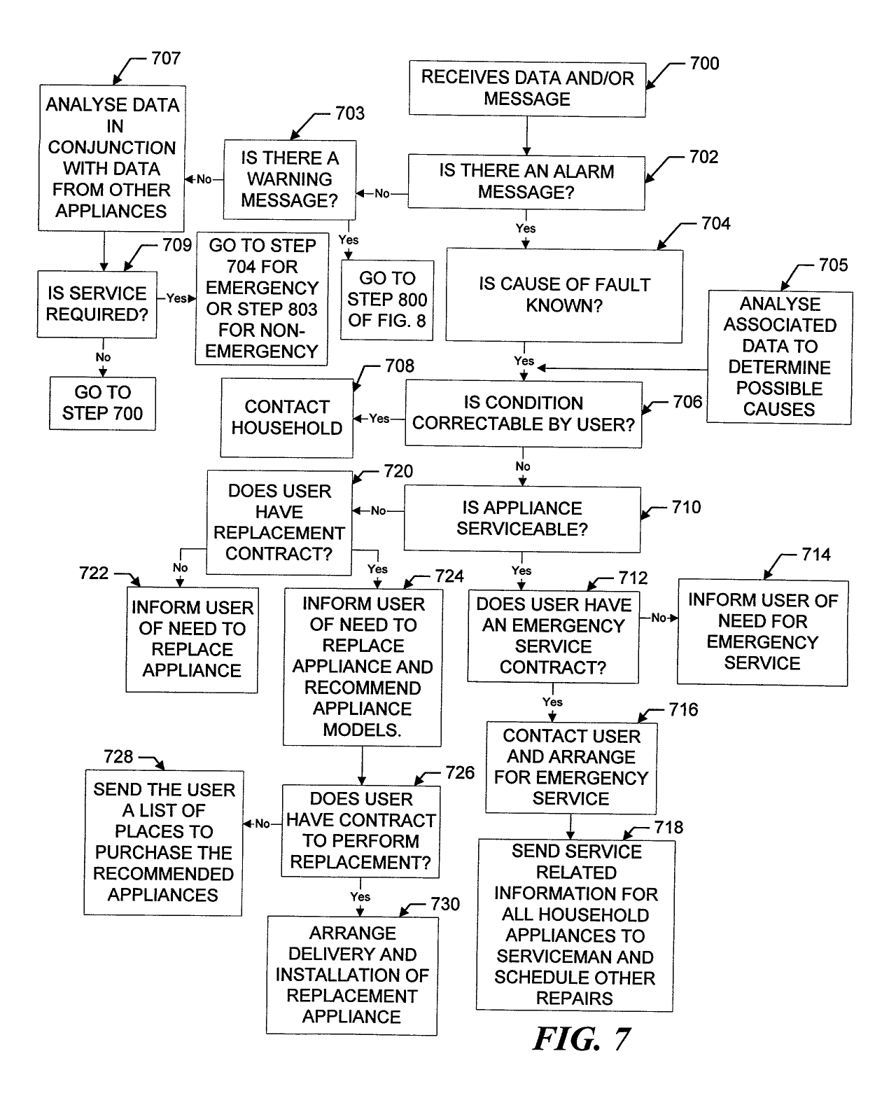

The remote center 50 responds to the messages based on the type and content of the messages and also on a level-of-service contract between the center and the user of the appliances. The remote center also performs a more detailed analysis of the monitored information to detect other alarm and warning conditions, and responds to the conditions based also on the level-of-service contract. As appropriate to the associated level of service contract, the remote center informs the appliance user about needed service for the appliances and/or arranges for repair, maintenance or replacement of the appliances through affiliated service companies 52 or through a service center 54 that handles the scheduling of service calls. The operations of the remote center are discussed below with reference to FIGS. 7-9.

The communications path 40 between the appliances 14-20 and the gateway 42 may be over a power line, a dedicated line, a telephone link or a wireless link. The gateway, which includes a modem, may be included in one of the appliances or may be, as shown in the drawing, a separate node on the network 10. The monitoring subsystem 30 may be one of two types, namely, a built-in system 32 that is incorporated into an “intelligent” appliance or an adaptor 34 that attaches to a “non-intelligent” appliance.

In the example, the refrigerator 14, oven 16 and washing machine 18 are intelligent appliances that include built-in monitoring subsystems 32. Throughout the appliance operating cycles the built-in subsystems continuously monitor the user-selected settings of the associated appliances, the states of various components and the readings of various sensors. Each subsystem retains the monitored information, or functional data, for at least the last operating cycle in a memory section 35. The subsystem also combines certain or all of the functional data for a series of operating cycles into historical data, and aggregates the historical data into statistical data that relates to all of the cycles performed by the appliance. An example of an intelligent appliance is the washing machine described in published European Application EP 0725 181 A1, which is incorporated herein by reference.

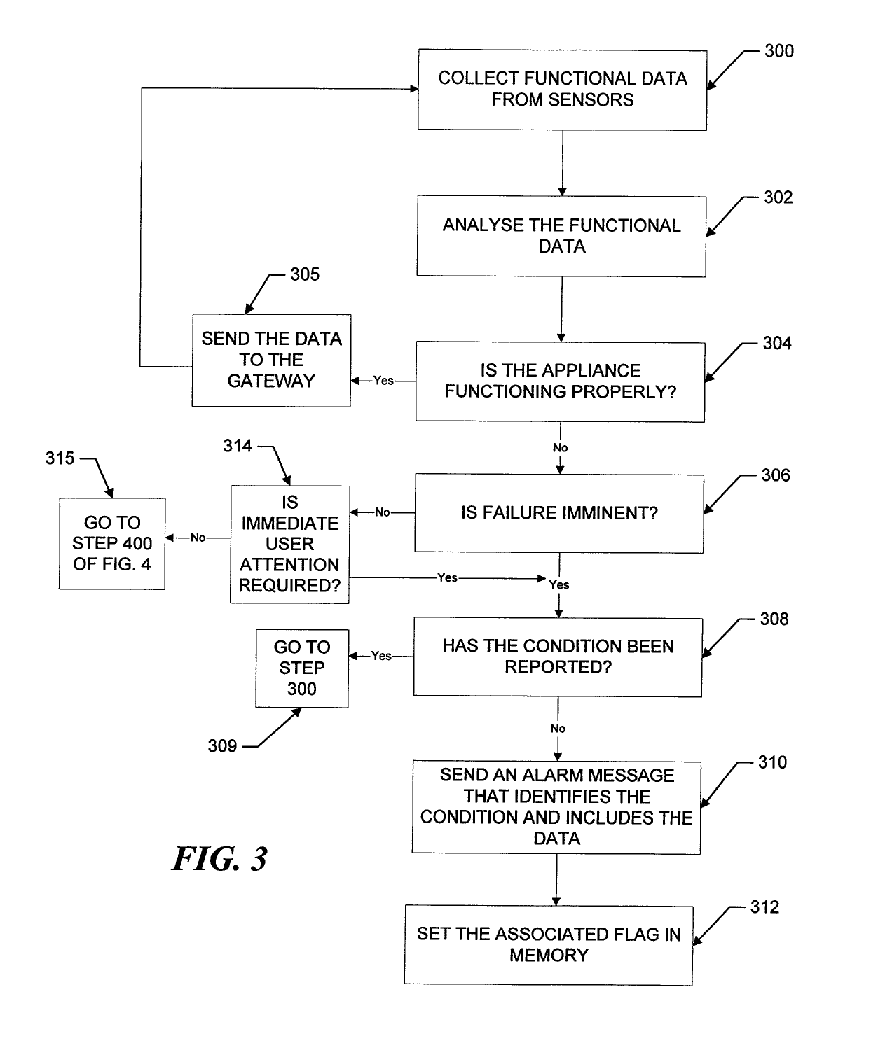

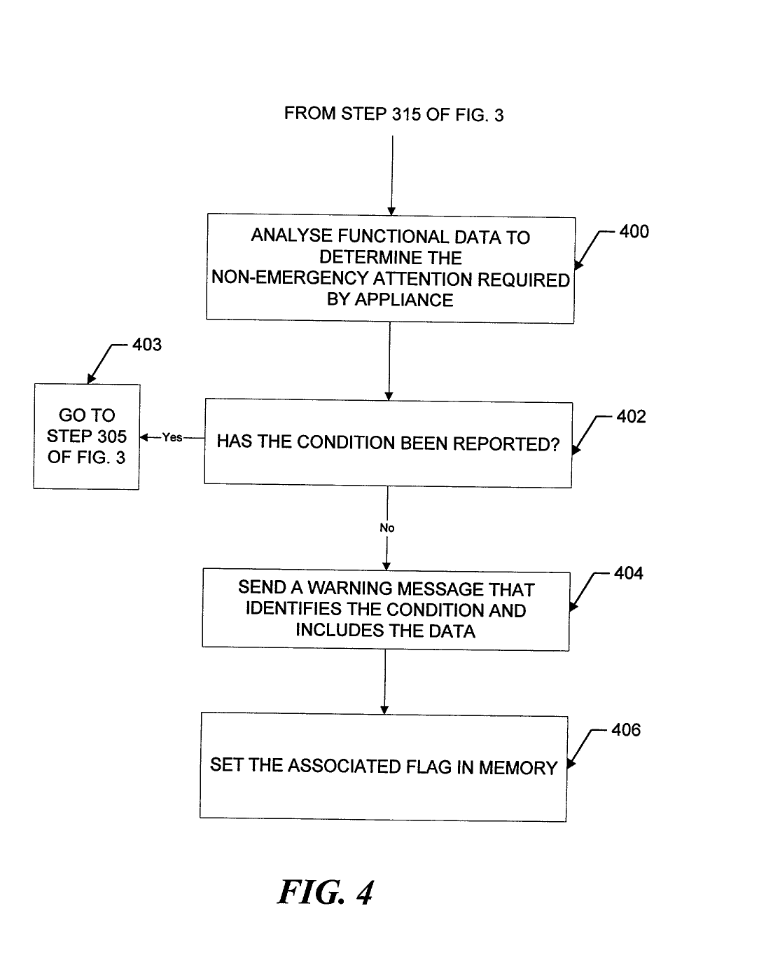

A processor 33 in the monitoring subsystem 32 analyzes certain of the functional, historical and statistical data during each operating cycle, to determine if the associated appliance is in need of immediate attention and/or emergency or non-emergency service. If the result of the analysis is that the appliance requires attention or service, the monitoring subsystem sends the data and the results of the analysis in the form of either the alarm message or the warning message over the network 10 via a network interface 37. Otherwise, the subsystem periodically sends the data over the network to the remote center, which performs a more detailed analysis of the operations of the appliances based on the data from the associated appliance and the data from all of the appliances. The operations of the built-in subsystem 32 are discussed in more detail below with reference to FIGS. 3-4. The questions of the remote center are discussed in more detail below with reference to FIG. 7.

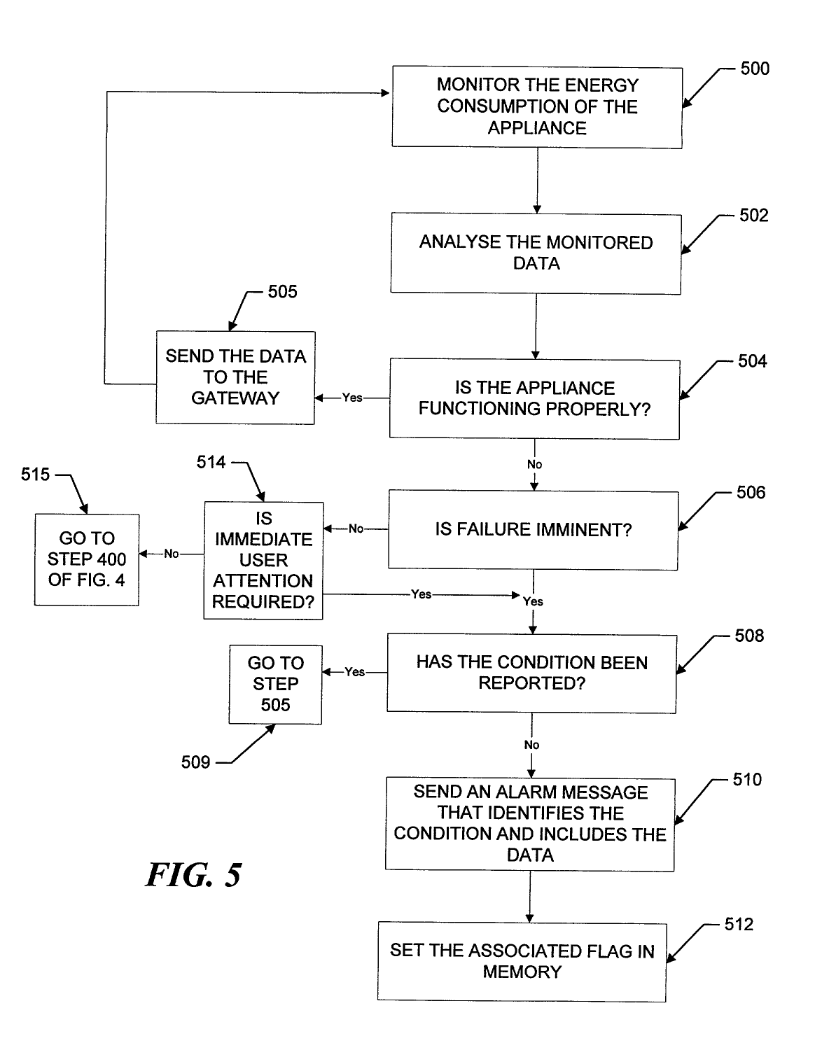

The illustrated dishwasher 20 and freezer 22 are “non-intelligent” appliances that are connected to the network 10 through adapters 34. Each adapter monitors at least the energy consumption of the associated appliance and retains, in memory 35, associated functional, historical and statistical energy consumption data. A processor 33 analyzes the energy consumption data and determines if the associated appliance is in need of immediate attention and/or emergency or non-emergency service. If the analysis reveals that the appliance requires attention or service, the adapter sends to the remote center 50 over the network 10 the data and the results of the analysis in the form of the alarm or warning messages. Otherwise, the adaptor periodically sends the monitored information to the remote center for further analysis. The operations of the adapter 34 are discussed in more detail below with reference to FIG. 5.

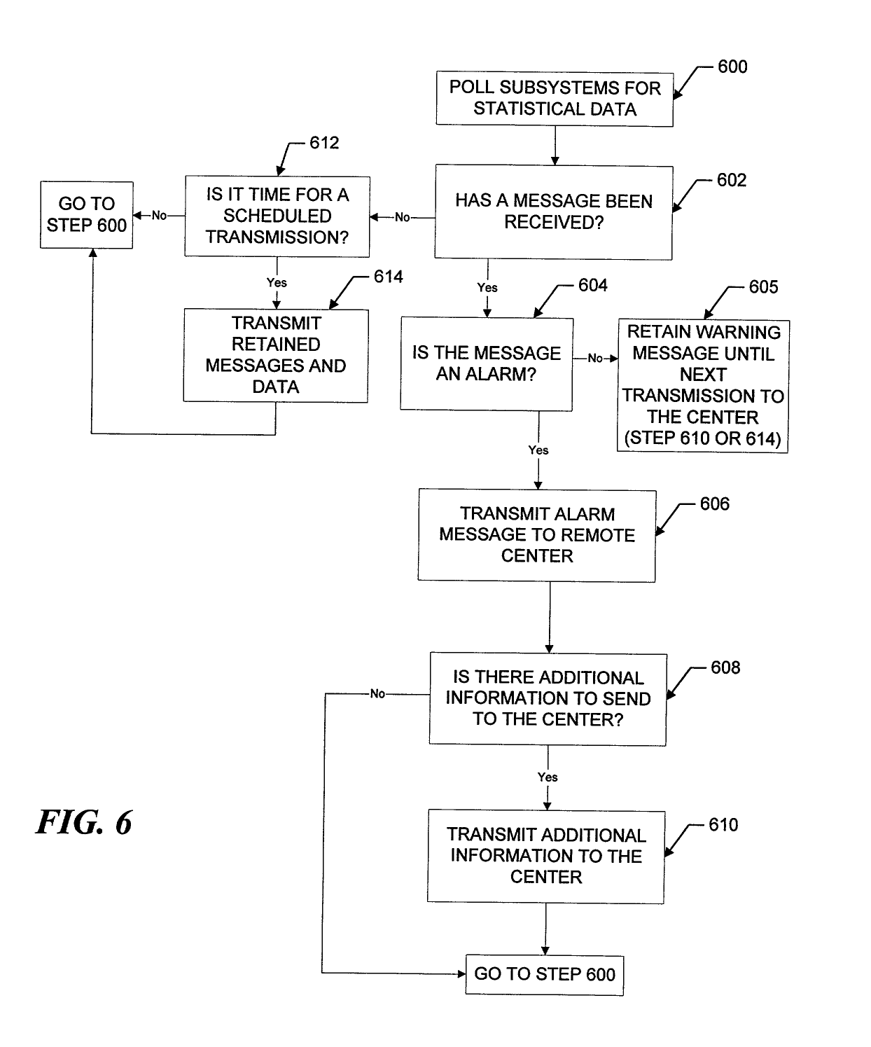

When the gateway 42 receives an alarm message over the network 10, the gateway immediately forwards the message to the remote center 50 via a telephone or cable line link 44. The gateway retains any received warning messages and transmits them to the remote center as part of a scheduled periodic transmission, for example, at the end of each week. If, in the meantime, the gateway receives an alarm message the gateway sends the alarm message and any retained warning messages to the remote center. The gateway also periodically polls the monitoring subsystems and requests up-to-date functional, historical and/or statistical data, and includes the data in the transmissions to the remote center. The operations of the gateway are discussed in more detail below with reference to FIG. 6.

When the remote center receives an alarm or warning message, the center notifies the user in accordance with the terms of the user's level of service contract and, as appropriate, schedules the indicated service. The remote center also performs a more detailed analysis of the associated data to determine if the appliances are in need of further attention; or require further emergency or non-emergency service, preventive maintenance and/or some other type of care. As part of the analysis, the center compares parameter values associated with the current operating cycle or a number of recent cycles with the values of the same parameters in the historical data, to determine if the appliance is operating properly. The center also analyses the statistical data to determine if the appliance has reached a preventative maintenance milestone. Further, the center includes in its analyses data from the other appliances, such as environmental information that is measured or sensed by the other appliances, and the center can thus determine adverse operating conditions and/or appliance operations that require attention. The remote center then arranges for indicated service in accordance with the users level of service contract.

The remote center also analyses at least the statistical data to determine patterns of usage for the respective appliances. Depending on the level-of-service contract, the remote center may also inform the user about more efficient ways to use the various appliances and/or recommend replacement models for the appliances. The operations of the remote center are discussed in more detail below with reference to FIGS. 7-9.

B. An Example of System Operation with Built-In Subsystems

1. Sending Alarm Messages

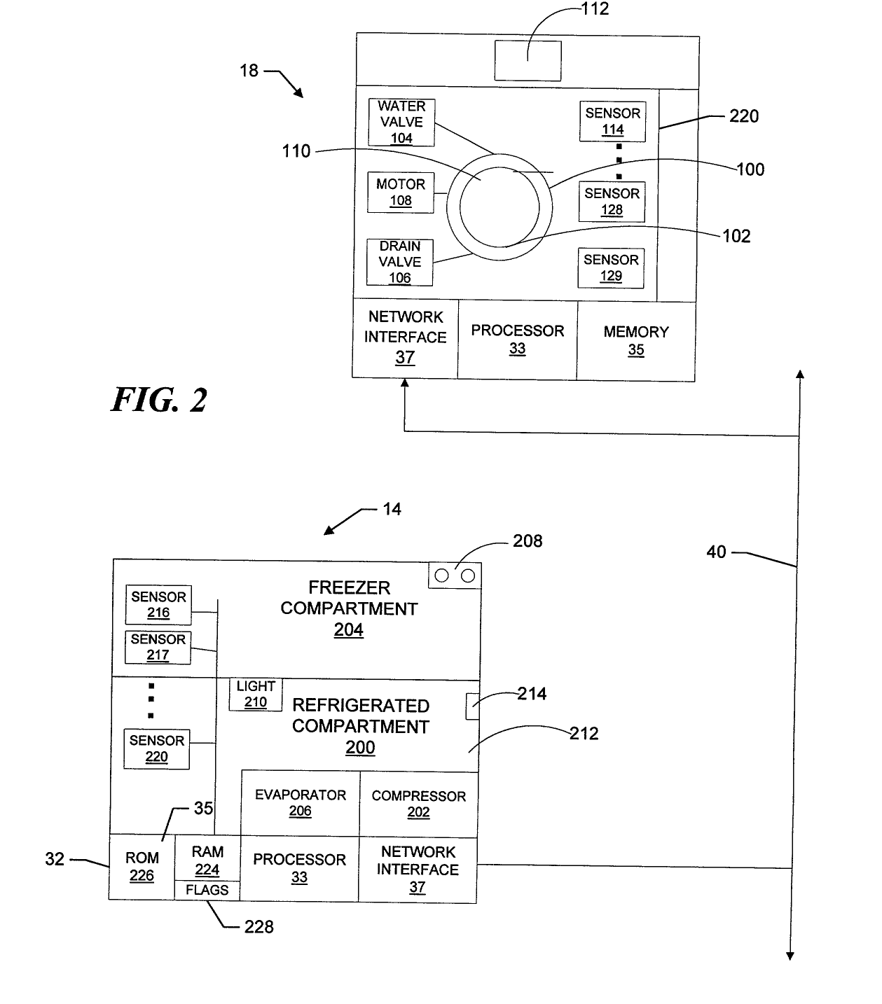

Referring now also to FIGS. 2 and 3, the refrigerator 14 includes a refrigerated compartment 200, a compressor 202, a freezer compartment 204, an evaporator 206, temperature control dials 208, a compartment light 210, a door 212, and a latch 214, and various sensors 216-220 for monitoring and controlling the operations of the refrigerator. A current sensor 216 measures the current drawn by the refrigerator, one or more temperature sensors 217 measure the temperatures of the compartments and, as appropriate, ambient temperature, an open-door sensor 218 detects when the door 212 is not latched, on-off sensors 219 sense the on and off states of the compressor 202, the evaporator 206 and the light 210, and a temperature control sensor 220 senses the user-selected temperature settings. The sensors provide functional data over a bus 222 to a RAM 224 that is included in the memory 35 of the monitoring subsystem 32. The RAM 224 may be any form of non-volatile memory, such as an EE PROM.

The monitoring subsystem 32 further includes a ROM 226 that contains the software that controls the operations of the processor 33. The ROM 226 may instead be any form of non-volatile memory such as an EE PROM. Under software control, the RAM 224 receives functional data from the sensors over the bus 222 (step 300), and the processor 33 then analyses certain of the data (step 302), to determine parameter values such as the start times and duration of the duty cycles of the compressor and the evaporator, the current drawn when the compressor and evaporator are turned on, the times the door opens and closes, the associated internal and ambient temperatures, the user-selected temperature settings, and so forth. As part of the analysis, the processor aggregates the data and calculated parameter values from several operating cycles into historical data that the system stores in the RAM 224. The subsystem may also compare the data and calculated parameter values from the most recent operating cycle to the historical data and/or to expected data values, to determine if the appliance is operating properly (step 304). Alternatively, the subsystem sends the data to the remote center, which performs all or part of the analysis.

In the example of the refrigerator, the subsystem 32 analyses the information associated with the most recent duty cycle of the compressor 202 taking into account monitored conditions, such as internal and ambient temperatures, current draw, and the length of time the door remained open. If the analysis reveals that certain parameters differ beyond predetermined limits from their expected values or the values in past cycles, the subsystem may determine that the operations represent, for example, an imminent failure of the compressor (step 306). The subsystem then checks if it has already reported the condition to the remote center by checking the state of an associated flag 228 in the memory 35 (step 308). If the condition has not been reported, the subsystem sends the monitored information and an alarm message that identifies the fault to the remote center 50 through the network interface 37 (step 310). The subsystem then sets the appropriate flag 228, to indicate that the message has been sent (step 312). If the message has already been sent, the subsystem does not send a duplicate.

The analysis performed by the monitoring subsystem 32 may also reveal that the associated appliance requires immediate attention from the user (step 314). The subsystem monitoring the refrigerator may, for example, determine that the door 204 has been left open longer than a predetermined maximum time limit. The subsystem first sets off a local alarm in an attempt to alert the user. The subsystem thus causes the refrigerated compartment light 210 to blink and, as appropriate, buzzers (not shown) to sound. Further, the subsystem sends a local alarm message over the network to the gateway 42 and the various other appliances in the household. In response the gateway and the other subsystems and adaptors blink indicator lights and/or sound buzzers in a predetermined pattern to alert the user of the condition. The user may respond to the alarm by shutting the refrigerator door. The subsystem then sends a message over the network instructing the gateway and other appliances to turn off the local alarm.

If the user does not acknowledge the local alarm within a predetermined time by, for example, shutting the refrigerator door or otherwise deactivating the associated alarm, the subsystem sends an alarm message to the remote center. The subsystem also sets the corresponding flag to signify that the open-door message was sent (steps 308, 310, 312). As appropriate, the subsystem sends a message to the other appliances instructing them to turn off the local alarm.

The washing machine 18 includes a tub 100 with an internal drum 102, one or more water valves 104 through which water is provided to the tub, a drain valve 106, a motor 108 for rotating the drum, a door 110, wash cycle control dials 112 and various sensors 114-129 for monitoring and controlling the operations of the washing machine. Water level sensors 114 detect when the water reaches predetermined levels, a water hardness sensor 116 determines water hardness, a load balance sensor 118 determines when the drum is off-balance, a sensor 120 measures the concentration of laundry detergent in the washing water, on-off sensors 122 sense the on-off states of the motor, a current sensor 124 measures current drawn, an open-lid sensor 126 detects when the lid is open, sensors 128 detect the states of the water and drain valves, and a settings control sensor 129 senses the user-controlled settings of the washing machine.

The monitoring subsystem 32 for the washing machine 18 receives the functional data from the sensors over the bus 222, and analyses certain of the data to determine whether the washing machine is operating properly. The monitoring subsystem 32 thus compares the sensor data associated with the most recent operating cycle with expected values and/or values from past cycles to determine if the washing machine is in danger of imminent failure. In the example, the subsystem compares the values associated with the current duty cycle of the motor 110 with those associated past or expected duty cycles, taking into account the water level and when the door 112 was opened or closed.

If the analysis reveals that the current duty cycle differs beyond predetermined limits from the past duty cycles and/or an expected duty cycle, the subsystem may, for example, determine that the operations represent imminent failure of the motor. The subsystem then checks the appropriate flag 228 to determine if the condition has been reported. If not, the subsystem sends an alarm message that identifies the indicated fault out over the network and sets the flag. Otherwise, the subsystem does not send a duplicate message.

2. Sending Warning Messages

Referring now also to FIG. 4, the analysis performed by the subsystem may also reveal that a critical component is operating poorly but not in danger of imminent failure (step 400). The refrigerator's monitoring subsystem may determine, for example, that the compressor is drawing increasing amounts of current but has not yet drawn an amount that exceeds a level associated with imminent failure. The subsystem 32 checks that the condition has not yet been reported and, as appropriate, sends a warning message that contains a fault code which indicates that the particular compressor requires non-emergency service (steps 402, 404). The subsystem similarly sends a warning message if the statistical data indicates that a preventative maintenance milestone, such as a number of cycles performed, has been achieved. The warning message may, for example, include a maintenance code that indicates that a particular filter should be replaced. After sending the message, the subsystem 32 sets the associated flags, to avoid the sending of duplicate warning messages during a subsequent operating cycle (step 403).

The built-in subsystems 32 also send at least the statistical data through the gateway 42 to the remote center 50, in response to polling by the gateway, as discussed below with reference to FIG. 6. As also discussed below, the remote center further analyses the information to detect other alarm and warning conditions.

C. An Example of System Operation with Adaptors

Referring now to FIG. 5, the adaptor 34 associated with the freezer 22 continuously monitors levels of voltage, current, power, and current-voltage phase displacement over time for each operating cycle (step 500). The adapter then analyses the data and compares the energy consumption patterns associated with the most recent operating cycle with expected patterns or with the patterns associated with past operating cycles. The adapter can determine when, for example, a compressor (not shown) turns on and off by the associated changes in the energy consumption patterns. The adapter can thus determine if the current compressor duty cycle differs from the expected or past duty cycles.

The adapter 34 can also determine certain changes in operating conditions that may explain differences in the energy consumption between the most recent and the past operating cycles. For example, the adapter can determine when the freezer door was opened or closed during a given cycle, based on a change in energy consumption associated with the freezer light turning on or off. The adapter can not, however, determine operating conditions that require direct sensing, such as, for example, the internal temperature of the freezer compartment or the temperature settings of the appliance.

Adaptors 34 that contain appropriate sensors and/or have access to such sensors can, however, determine environmental conditions such as ambient temperature. Further, the adaptor may detect certain appliance problems from sensed external conditions. For example, the adaptor associated with the dishwasher may include a water leakage sensor and thus detect a condition that may be an internal or external line break or a faulty valve.

Based on the results of the analysis, the adapter 34 produces appropriate alarm and warning messages (steps 506-512). While the adapter may have access to less overall functional data than the built-in subsystem 32, the data available to the adaptor is generally sufficient to determine when the associated appliance is operating poorly or when certain key components have failed. The adaptor may not, however, be able to determine the causes of the malfunctions. The adaptor also produces historical and statistical data, in the form of various data points from plots of associated energy consumption variables versus time, and sends the data to the remote center for further analysis.

D. The Gateway

Referring now to FIG. 6, the gateway 42 polls the subsystems for statistical data and receives messages from the appliances over the network (steps 600, 602). When a message is received, the gateway must first determine whether the message is an alarm message or a warning message (steps 602, 604). The gateway thus checks the message field in the header. If the message is an alarm message, the gateway immediately transmits the message to the remote center 50 (step 606). When the gateway receives a warning message, the gateway retains the message until a next transmission is made to the remote center (step 605).

Each time the gateway transmits an alarm message to the remote center the gateway sends all of the information that the gateway is then holding (steps 608, 610). The gateway thus sends retained warning messages, and the statistical information provided by the appliances in response to polling. In this way, the remote center has up-to-date information about the appliances and can, as discussed below, coordinate repairs, maintenance and replacement of the appliances.

The gateway 42 preferably polls the subsystems when the network is otherwise relatively free, such as late in the day or early in the morning. The gateway then retains the data returned by the various appliances until a next transmission to the remote center.

E. The Remote Center

Referring now to FIG. 7, when the remote center 50 receives a message, the center first determines if the message is an alarm message or a warning message (steps 700, 702). The remote center thus checks the message field in the message header.

The remote center responds to an alarm message by first determining if the cause of the alarm condition is known from the message (step 704). The remote center thus uses the fault code contained in the message to enter a stored look-up table (not shown) that contains explanations of the codes. If the cause is known, the remote center determines if the alarm relates to a user-correctable condition, such as an open door or a manually closed valve (step 706). If so, the remote center consults stored user-contact information and contacts the user at specified numbers, such as a home phone and a cell phone to report the identified condition (step 708). If the center cannot reach the user, the center leaves an appropriate message on voice mail or an answering machine.

If the alarm message relates instead to a catastrophic failure of the appliance or the imminent failure of a key component, the remote center analyses the associated functional historical and statistical data to determine if the appliance is serviceable and/or should be serviced or replaced (step 710). If the appliance is to be serviced, the remote center consults its stored user-contract information, to determine if this particular user has a service contract that requires the scheduling of service calls (step 712). If so, the remote center notifies the user of the fault condition, and also arranges for emergency service for the appliance through one of its own repairmen or, as appropriate, by referring the call to an associated service center (step 716).

The remote center also analyses the data from this appliance in conjunction with the data from the other appliances in the household and other appliances of the same type that report to the remote center, to determine if other service is required for this appliance or any other appliance in the household. The center then informs the serviceman or service center of any indicated service for the appliances, so that the serviceman can coordinate the repairs (step 718). The remote center or the serviceman may also further analyze functional, historical and/or statistical data, to determine the causes of the various fault conditions and/or what parts require replacement.

If the user does not have a contract that provides for the arranging of service, the remote center instead informs the user of the need for the emergency service and recommends that the user contact one or more servicemen or the service center (step 714). The user is then expected to arrange for the emergency service on his or her own.

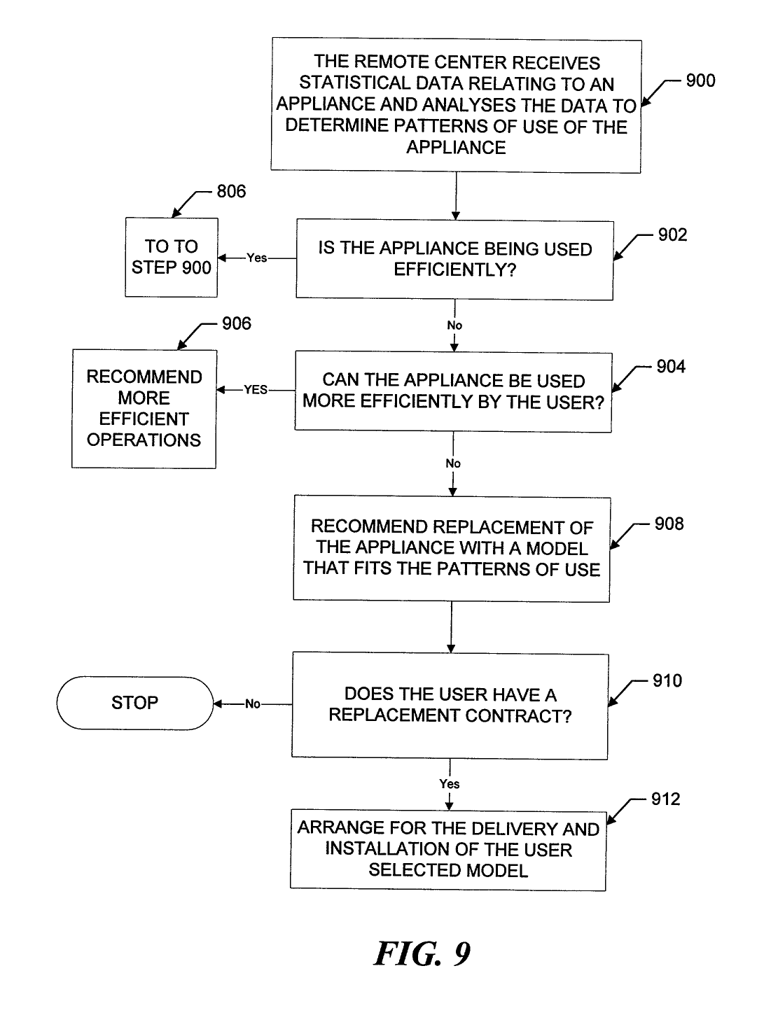

If the appliance is not serviceable, such as a water heater (not shown) with a ruptured tank, the remote center checks its stored user contract information to determine if the user's contract covers appliance replacement (step 720). If so, the remote center informs the user of a need to replace the appliance, and recommends one or more replacement appliances (step 724), based on an analysis of the patterns of use of the appliance, as discussed below with reference to FIG. 9. As appropriate, the remote center also informs the user where he or she may purchase the recommended replacement appliances (steps 728, 730). If the contract also includes arranging for the replacement of the appliance, the remote center schedules the delivery and installation of the replacement appliance purchased by the user (step 732).

If the user does not have a contract that covers appliance replacement, the center informs the user of the need to replace the appliance (step 722).

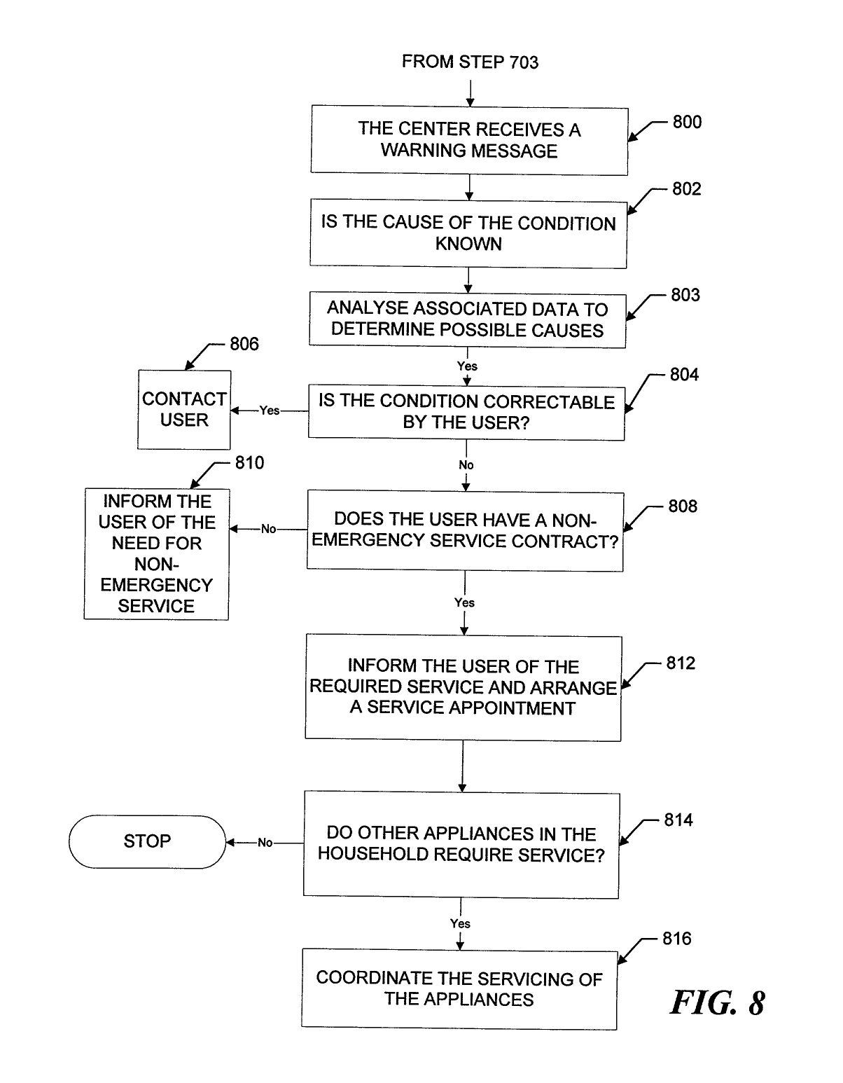

Referring now to FIG. 8, when the remote center 50 receives a warning message, the center determines whether or not the message indicates the cause of the warning condition (steps 800, 802). If maintenance or other service is indicated, the center determines if the required maintenance is one that a user generally performs, such as the replacing of a filter (step 804). If so, the center sends instructions to the user to perform the indicated maintenance (step 806).

If the service is not one that is generally performed by the user, the remote center 50 consults stored contract information, to determine if the user has a service contract (step 808). If not, the remote center sends a message to the user regarding the required service (step 810), and the user then has to arrange to have the service performed. Otherwise, the system notifies the user of the required service and arranges a service appointment that is convenient to both the user and the repairman (step 812). The center also preferably determines if that appliance or any other appliance in the household are in need of additional service and, if possible, arranges for these services to be performed during the same service call (steps 814).

Referring again to FIG. 7, the remote center receives data from each of the appliances both periodically and with the alarm and warning messages (step 700). The remote center performs more detailed analyses of the operations of the various appliances using all of the data (steps 705, 707, 803). The remote center can thus more thoroughly review the operations of the individual appliances and the overall operating and environmental conditions to determine if a particular appliance requires service or is instead responding to changes in its operating environment.

Further, the remote center can also predict when an appliance is about to malfunction based on an analysis of the operations of the appliance in comparison with other appliances of the same type in other households that report to the center. For example, the remote center may recognize in a given appliance an operating characteristic that has preceded a particular failure in other appliances of the same type. The remote center can thus schedule pre-emptive maintenance, to avoid the failure of the given appliance.

The remote center can thus provide much more insight into the operations of the various appliances and, in particular, into those appliances that are associated with the adaptors than can a single appliance that is analyzing just its own data. Further, the remote center can upgrade its analysis procedures as new ways of interpreting the data are realized, and thus, provide the most up-to-date analysis for each appliance.

Referring now to FIG. 9, the remote center further analyses the data compiled by the appliances to determine patterns of use for the respective appliances (step 900). The remote center then determines if a particular appliance is being used inefficiently in terms of temperature settings, water settings, detergent quantities, and so forth (step 902). If so, the center recommends more appropriate temperature and water settings and/or detergent use to the user (step 906).

In the example, the remote center analyses information provided by the intelligent washing machine 18 (FIG. 12) to determine the size of a given load, the type of fabric included in the wash, the machine settings selected by the user for the wash, i.e., load size, temperature, and wash cycle selection, and amount and type of detergent used, and includes this information in the statistical data that is ultimately sent to the remote center. The remote center then analyses the data to determine if the washing machine is both operating properly and/or being used efficiently. In the example, the center checks the fabrics washed and the associated machine settings, and determines that the user is washing delicate fabrics at too high a temperature. The remote center then recommends to the user that he or she wash the delicate fabrics at a lower temperature, to prevent harming the fabric and to save energy.

The remote center may also recommend to the user that the appliance should be replaced (step 908), in order to save water or energy or prevent unnecessary wear and tear on the appliance, even if replacement is not otherwise indicated by the age of the S appliance or the number of cycles performed by the appliance. For example, a user who owns a large capacity washing machine and washes only small loads may be better served in terms of water and energy conservation by using a smaller capacity washer. Conversely, a user who relatively often washes loads that fill the washer may be better served in terms of reduced maintenance and repair costs by using a higher capacity washer less frequently and at less than full capacity. The remote center thus recommends to the user that the current model washing machine be replaced with one more appropriate for the user (step 908). If the user's contract covers appliance replacement, the center also arranges for the delivery and installation of the selected replacement appliance (steps 910, 912).

The remote center may process and/or analyze the data from the appliances automatically, semi-automatically or manually. Further, the center may generate the messages for the user and/or the service people automatically, semi-automatically or manually based, in part, on the associated level of service contract.

The appliance monitoring system 10 provides user-specific care and maintenance to the household appliances based on an analysis of monitored conditions. The conditions may but need not be associated with diagnosing appliance malfunction. Further, the system coordinates the servicing of each of the appliances and arranges service appointments for the user. The system makes service calls as convenient as possible for the user by coordinating repairs and maintenance for all of the appliances. The center may also make service calls more convenient for the serviceman by, for example, coordinating the servicing of the appliances with the servicing of appliances in is nearby households. The system also determines patterns of use for the various appliances and makes user-specific recommendations for more efficient use patterns and/or appliance replacement models in order to reduce the need for service calls.

What is claimed is:

1. A system for servicing household appliances, the system including:
A. one or more monitoring subsystems associated with the one or more appliances, each monitoring subsystem
i. monitoring the operations of a given appliance and retaining as functional data information relating to the functioning of the appliance,
ii. analyzing the functional data and determining if the appliance is operating properly or in need of attention, and
iii. transmitting a message indicating that the appliance requires attention, and
B. a center for receiving the messages sent by the monitoring subsystems, the center contacting the users of the associated appliances to inform them that the appliances require attention.

2. The system of claim 1 wherein each monitoring subsystem
a. determines if the associated appliance requires immediate attention,
b. produces alarm messages when immediate attention is required, and
c. produces warning messages when other than immediate attention is required.

3. The system of claim 1 wherein
a. the monitoring subsystem sends the functional data or aggregations of the data to the center; and
b. the center processes the data to determine if one or more of the appliances requires service.

4. The system of claim 3 wherein the center
i. determines from the received data or messages what attention is required for a given appliance,
ii. determines, if service is required, whether the user of the appliance has a service contract for the appliance, and
iii. arranges service in accordance with the provisions of the contract, if the user has a service contract.

5. The system of claim 4 wherein the center further
iv. determines, if preventive maintenance is required, whether the maintenance is performed by the user or an appliance service person,
v. determines, if the maintenance is to be performed by a service person, whether the user has a maintenance contract for the appliance and arranges maintenance in accordance with the provisions of the contract, and
vi. notifies the user what preventive maintenance is to be done if the maintenance is to be performed by the user.

6. The system of claim 2 further including
C. a network over which the monitoring subsystems transmit the messages;
D. a gateway connected to the network to receive the messages, the gateway
a. transmitting alarm messages to the center as soon as the messages are received, and
b. retaining warning messages and transmitting the retained messages at predetermined times or when other transmissions are made to the center.

7. The system of claim 6 wherein
i. each monitoring subsystem aggregates the functional data over time into statistical data that relates to the operations of the associated appliance,
j. the gateway polls each monitoring subsystem to request the statistical data,
k. the gateway transmits the statistical data to the center at predetermined times or when other transmissions are made to the center, and
l. the center includes the statistical data in an analysis of the patterns of use and the operations of the appliances.

8. The system of claim 7 wherein the center
i. determines if a given appliance should be replaced based on the associated patterns of use,
ii. recommends at appropriate times the replacement of the appliance with one or more appliance models that fit the associated pattern of use,
iii. determines if the user of the given appliance has a replacement contract, and if so, arranges for the delivery and installation of the replacement appliance model selected by the user.

9. The system of claim 1 wherein one or more of the monitoring subsystems are adapters that monitor and analyze the energy consumption of the associated appliances.

10. The system of claim 1 wherein one or more of the monitoring subsystems monitor the settings of the associated appliances, and the states of various components of the appliances.

11. The system of claim 10 wherein the monitoring subsystems aggregate the functional data into historical data, and use the historical data in the analysis of the operations of the appliances.

12. A method for servicing household appliances, the method including the steps of:
A. monitoring the operations of one or more appliances and retaining as functional data information relating to the functioning of the respective appliances;
B. analyzing the functional data at the appliances and determining if the respective appliances are operating properly or in need of attention;
C. transmitting to a remote center one or more messages indicating that the appliance requires attention; and
D. from the center contacting the users of the associated appliances to inform them that the associated appliances require attention.

13. The method of claim 12 further including the steps of
a. transmitting data from the appliances to the center,
b. analyzing the data from all of the appliances in the household to determine if one or more appliances requires service.

14. The method of claim 13 wherein
d. the step of analyzing at the appliance further includes determining if a given appliance requires immediate attention, and
e. the step of transmitting one or more messages further includes producing alarm messages when immediate attention is required and producing warning messages when other than immediate attention is required.

15. The method of claim 14 wherein the step of contacting includes
iv. determining from the received messages or an analysis of the data what attention is required for a given appliance,
v. determining, if service is required, whether the user of the appliance has a service contract for the appliance, and
vi. arranging service in accordance with the provisions of the contract, if the user has a service contract.

16. The method of claim 15 wherein the step of contacting further includes
vii. determining, if preventive maintenance is required, whether the maintenance is performed by the user or an appliance service person,
viii. determining, if the maintenance is to be performed by a service person, whether the user has a maintenance contract for the appliance,
ix. arranging maintenance in accordance with the provisions of the contract, and
x. notifying the user what preventive maintenance is to be done if the maintenance is to be performed by the user.

17. The method of claim 13 wherein the steps of transmitting include
a. transmitting the messages and data over a network to a gateway,
b. transmitting alarm messages and associated data from the gateway to the center as soon as the messages are received by the gateway, and
c. retaining warning messages and data at the gateway and transmitting the retained messages at predetermined times or when other transmissions are made to the center.

18. The method of claim 17 wherein
i. the step of analyzing further includes aggregating the functional data over time into statistical data that relates to the operations of the associated appliance,
ii. the steps of transmitting further include polling from the gateway to request the statistical data and other data and transmitting the requested data to the center at predetermined times or when other transmissions are made to the center, and
iii. the method further includes the step of including the statistical data in an analysis of the patterns of use and the operations of the appliances.

19. The method of claim 18 wherein the method further includes the steps of
iv. determining if a given appliance should be replaced based on the analysis of patterns of use,
v. recommending replacement appliance models that fit the associated pattern of use,
vi. determining if the user of the given appliance has a replacement contract, and if so, arranging for the delivery and installation of the replacement appliance model selected by the user.

20. The method of claim 12 wherein the step of monitoring includes monitoring the energy consumption of one or more of the appliances.

21. The method of claim 20 wherein the step of monitoring includes monitoring the user-controlled settings of the associated appliances, the ambient environment and the states of various components of the appliances.

22. The method of claim 21 wherein the step of analyzing includes aggregating the functional data into historical data, and using the historical data in the analysis of the operations of the appliances.

23. The method of claim 22 further including the steps of
i. transmitting the functional data to the remote center;
ii. analysing the data at the remote center to determine if the one or more appliances are in need of attention.

24. A system for servicing household appliances, the system including:
A. one or more monitoring subsystems associated with the one or more appliances, each monitoring subsystem
i. monitoring the operations of a given appliance and retaining as functional data information relating to the functioning of the appliance,
ii. analyzing the functional data and determining if the appliance is operating properly or in need of attention, and
iii. transmitting a message indicating that the appliance requires attention and the associated data,
iv. periodically transmitting the functional data,
E. a c center for receiving the messages and the data sent by the monitoring subsystems, the center analyzing the messages and the data and contacting the users of the associated appliances to inform them of the attention required by the appliances.

25. The system of claim 24 wherein the center analyses the data from all of the appliances in the same household to determine changes in operating environment and uses the results in an analysis of the operations of the various appliance in the same household.

26. The system of claim 24 wherein the center analyses the data from a given type of appliance in the various households that report to the center and uses the results in an analysis of the operations of that type of appliance in each of the households.
